(19) United States
(12) Patent Application Publication
(10) Pub. No.: US 2021/0339599 A1
(43) Pub. Date: Nov. 4, 2021

(54) THERMAL MANAGEMENT DEVICE FOR AN ELECTRIC POWER STORAGE DEVICE FOR A MOTOR VEHICLE

(71) Applicant: Valeo Systemes Thermiques, Le Mesnil-Saint-Denis Cedex (FR)

(72) Inventors: Eric Tudeau, La Suze Sur Sarthe (FR); Jean Damien Muller, La Suze Sur Sarthe (FR); Antonio De Figueiredo, La Suze Sur Sarthe (FR)

(73) Assignee: Valeo Systemes Thermiques, Le Mesnil-Saint-Denis Cedex (FR)

(21) Appl. No.: 17/279,781

(22) PCT Filed: Sep. 26, 2019
(86) PCT No.: PCT/FR2019/052283

§ 371 Date: Mar. 25, 2021

(30) Foreign Application Priority Data
Sep. 27, 2018 (FR) 1858865

(51) Int. Cl. B60H 1/00; H01M 10/6556

(52) U.S. Cl. CPC B60H 1/00278; H01M 2220/20; B60H 1/00328; H01M 10/6556

(57) ABSTRACT

The present invention relates to a thermal management device (1) for an electrical storage device for a motor vehicle, said thermal management device (1) comprising at least one thermal exchange plate (10A, 10B, 10C), inside which a thermal exchange circuit is provided, inside which a heat-transfer fluid is intended to circulate, the thermal exchange plate (10A, 10B, 10C) comprising a circulation channel (16A, 16A′, 165B, 165C), at least one of the ends (60A, 60B, 60C) of which opens into one of the portions of said thermal exchange plate (10A, 10B, 10C), said opening end (60A, 60B, 60C) being obstructed by a plug (70) crimped on the portion of the thermal exchange plate (10A, 10B, 10C), said portion comprising, at the opening end (60A, 60B, 60C) of the circulation channel (16A, 16A′, 165B, 165C), a recess (61), inside which the plug (70) is inserted, the plug (70) comprising an upper part (71) covering the opening end (60A, 60B, 60C) and having a height that is less than the depth of said recess (61), the recess (61) comprising, on the rims (610) thereof, at least two portions (62) that are at least locally flattened and pushed toward the inside of said recess (61), so as to at least partially cover the edges of the upper part (71) of the plug (70).

The field of the present invention relates to the thermal regulation of an electrical storage device and, more particularly, the present invention relates to the thermal regulation of an electrical storage device intended for electric or hybrid motor vehicles.

Electric and hybrid vehicles are currently equipped with an electrical storage device. Such an electrical storage device is formed by an assembly of electrical modules, which are formed by an assembly of electrochemical cells.

In order to ensure the autonomy, performance and reliability of such an electrical storage device, the electrical storage device needs to be thermally regulated. The aim of thermal management of the electrical storage device is to keep the temperature of its constituent electrical modules at a temperature approximately ranging between 20° C. and 40° C. Indeed, when the temperature of an electrical module is too low, the capacity of its electrochemical cells decreases and when the temperature of an electrical module is too high, the service life of its electrochemical cells is degraded. In order to ensure this thermal management, the use of a thermal management device is known that comprises at least one heat exchange plate positioned directly in contact with an electrical module of the electrical storage device and through which a heat-transfer fluid passes.

In order for the heat-transfer fluid to circulate, the one or more heat exchange plates are traversed by a thermal exchange circuit formed, for example, by ducts provided in the one or more thermal exchange plates themselves. This thermal exchange circuit generally comprises circulation channels, the ends of which open into the portions of the thermal exchange plates. These opening ends are obstructed by plugs in order to close the thermal exchange circuit. These plugs are generally glued, brazed or even welded to the heat exchange plate.

This attachment of the plugs as described above requires significant implementation means and is by no means the easiest attachment to implement. Indeed, attachment by gluing requires preparation of the surface, which increases the manufacturing time and therefore the production costs. Attachment by brazing or welding for its part requires significant heating means, which are energy-intensive and are therefore also expensive.

One of the aims of the present invention is to at least partially overcome the disadvantages of the prior art and to propose an improved thermal management device, in particular with respect to the attachment of the plugs obstructing the opening ends of the circulation channels.

Therefore, the present invention relates to a thermal management device for an electrical storage device for a motor vehicle, said thermal management device comprising at least one thermal exchange plate, inside which a thermal exchange circuit is provided, inside which a heat-transfer fluid is intended to circulate, the thermal exchange plate comprising a circulation channel, at least one of the ends of which opens into one of the portions of said thermal exchange plate, said opening end being obstructed by a plug crimped on the portion of the thermal exchange plate, said portion comprising, at the opening end of the circulation channel, a recess, inside which the plug is inserted, the plug comprising an upper part covering the opening end and having a height that is less than the depth of said recess, the recess comprising, on the rims thereof, at least two portions that are at least locally flattened and pushed toward the inside of said recess, so as to at least partially cover the edges of the upper part of the plug.

Crimping the plug on the thermal exchange plate provides the seal for the circulation channels without having to use heavy and energy-intensive means such as brazing.

According to one aspect of the invention, the recess is produced over the entire thickness of the portion.

According to another aspect of the invention, the rims of the recess are flattened and pushed toward the inside of the recess over the entire thickness of the portion.

According to another aspect of the invention, the rims of the recess are flattened and pushed toward the inside of the recess over part of the thickness of the portion.

According to another aspect of the invention, the plug comprises a seal disposed between the upper part thereof and the bottom of the recess.

According to another aspect of the invention, the opening end of the circulation channel forms an opening and in that the plug comprises a tenon disposed perpendicular to the upper part thereof, said tenon being inserted inside said opening.

According to another aspect of the invention, the opening and the circulation channel have an oblong section, said opening being longer than said circulation channel, so as to form two shoulders at the bottom of said opening, the tenon of the plug facing said shoulders.

According to another aspect of the invention, the plug comprises a seal surrounding the tenon and coming into contact with the internal wall of the opening.

According to another aspect of the invention, the seal disposed between the upper part of the plug and the bottom of the recess is produced in one piece with the seal surrounding the tenon.

Further features and advantages of the invention will become more clearly apparent from reading the following description, which is provided by way of a non-limiting example, and with reference to the appended drawings, in which:

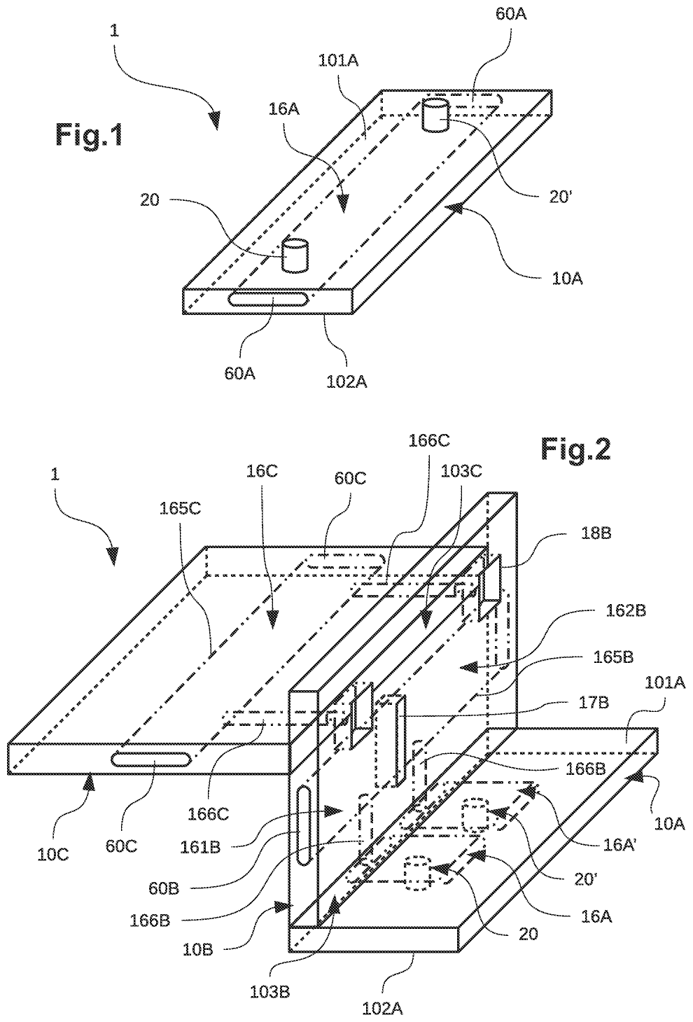

FIG. 1 shows a perspective schematic representation of a thermal management device according to a first embodiment;

FIG. 2 shows a perspective schematic representation of a thermal management device according to a second embodiment;

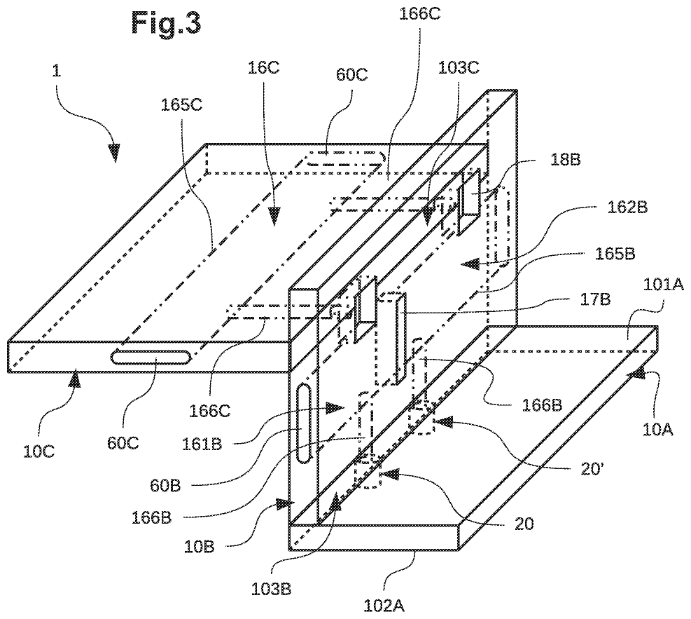

FIG. 3 shows a perspective schematic representation of a thermal management device according to a third embodiment;

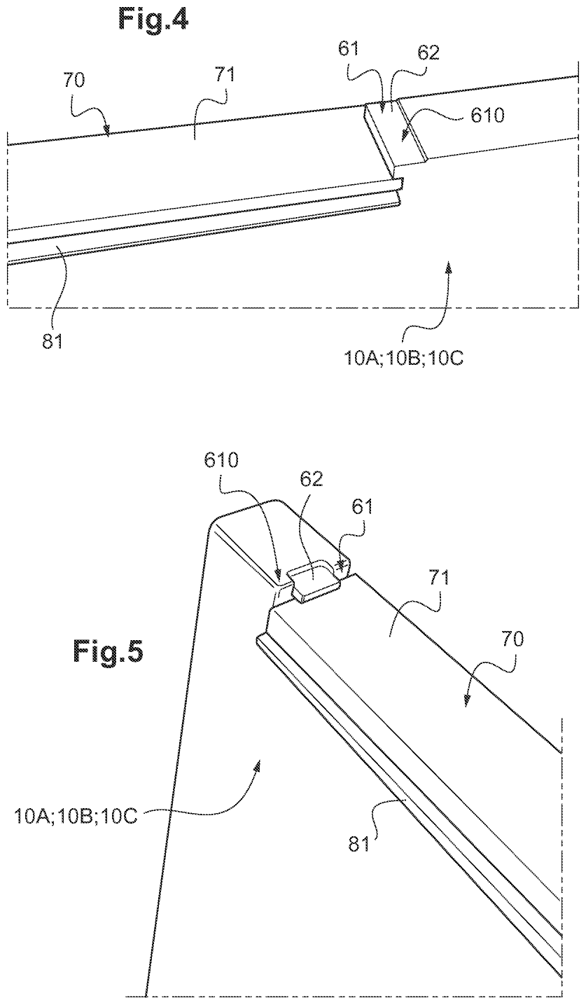

FIG. 4 shows a perspective schematic representation of the attachment of a plug according to a first embodiment;

FIG. 5 shows a perspective schematic representation of the attachment of a plug according to a second embodiment;

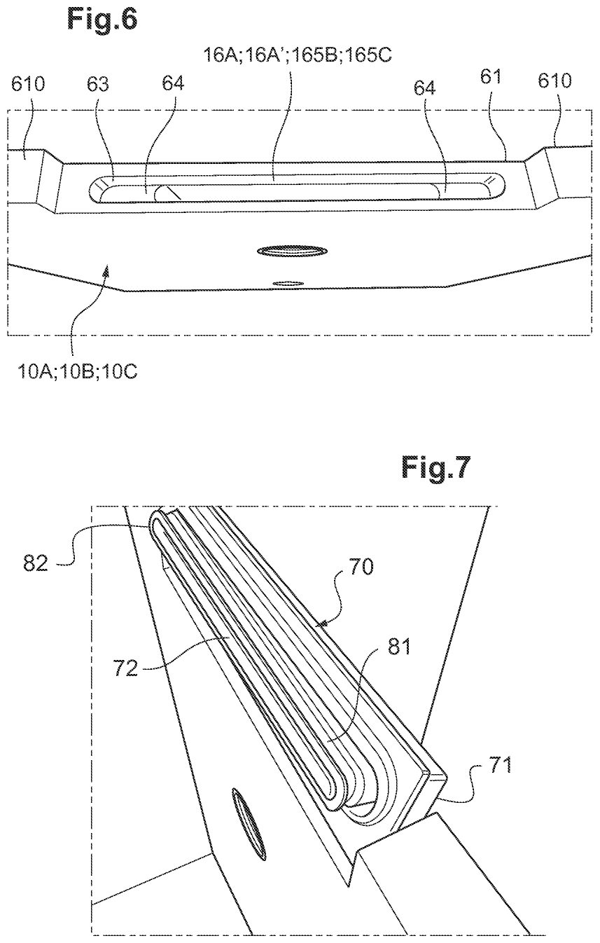

FIG. 6 shows a perspective schematic representation of the section of a thermal exchange plate;

FIG. 7 shows a perspective schematic representation of a plug.

In the various figures, identical elements bear the same reference numbers.

The following embodiments are examples. Although the description refers to one or more embodiments, this does not necessarily mean that each reference relates to the same embodiment, or that the features apply only to one embodiment. Individual features of various embodiments can also be combined in order to provide other embodiments.

In the present description, some elements or parameters can be indexed, such as, for example, first element or second element, as well as first parameter and second parameter or even first criterion and second criterion, etc. In this case, this is simple indexing for differentiating and denoting elements or parameters or criteria that are similar but not identical. This indexing does not imply any priority of one element, parameter or criterion over another and such denominations can be easily interchanged without departing from the scope of the present description. Furthermore, this indexing does not imply any chronological order, for example, in assessing any given criterion.

FIG. 1 shows a thermal management device 1 for an electrical storage device for a motor vehicle. This thermal management device 1 comprises at least one thermal exchange and connection plate 10A, inside which a thermal exchange circuit is provided, inside which a heat transfer circuit is intended to circulate. This thermal exchange and connection plate 10A comprises a first 101A and a second 102A flat wall parallel to each other. One of its first 101A and second 102A walls also comprises at least one fitting 20, 20′ for connecting to the thermal exchange circuit. This connection fitting 20, 20′ is crimped in this first 101A or second 102A wall and projects therefrom.

The thermal management device 1 can be simple, as illustrated in FIG. 1, and only comprise one thermal exchange and connection plate 10A, on which one or more electrical storage devices is/are intended to come into contact at one of the first 101A or second 102A walls thereof. The thermal exchange circuit then can be limited to a circulation channel 16A produced in the thickness of the thermal exchange and connection plate 10A. This circulation channel 16A extends parallel to the first 101A and second walls 102A.

The thermal exchange and connection plate 10A can be produced in one piece. The circulation channel 16A can be produced by machining in the thickness of the thermal exchange and connection plate 10A or the thermal exchange and connection plate 10A even can be extruded. The circulation channel 16A thus comprises at least one opening end 60A at the portion of the thermal exchange and connection plate 10A. In FIG. 1, the circulation channel 16A comprises two opening ends 60A at two opposite portions. These opening ends 60A are more particularly plugged, for example, by a plug 70 (shown in FIGS. 4 and 5).

The thermal management device 1 can be more complex, as illustrated in FIGS. 2 and 3, and can comprise a plurality of thermal exchange plates 10A, 10B, 10C. In the embodiment illustrated in FIGS. 2 and 3, the thermal management device 1 comprises a first thermal exchange plate 10C extending in a first plane, a second thermal exchange plate 10B extending in a second plane intersecting the first plane and adhered to one of the portions 103C of the first thermal exchange plate 10C and a thermal exchange and connection plate 10A being in a third plane parallel to the first plane and adhered to a portion 103B of the second thermal exchange plate 10B.

The thermal exchange circuit thus comprises a circulation duct 16C provided in the first thermal exchange plate 10C and extending in the same plane as said first thermal exchange plate 10C. This circulation duct 16C comprises a heat-transfer fluid inlet and outlet on the portion 103C on which the second thermal exchange plate 10B is adhered. This circulation duct 16C particularly can comprise a circulation channel, called main channel 165C, and two secondary channels 166C.

The main channel 165C can be machined in the thickness of the first thermal exchange plate 10C or the main channel 165C even can be formed at the same time as the first plate 10C if said plate is extruded. For their part, the secondary channels 166C can be machined in the thickness of the first thermal exchange plate 10C. The main channel 165A thus comprises at least one end 60C opening at a portion of the first thermal exchange plate 10C. In FIGS. 2 and 3, the main channel 165C comprises two opening ends 60C at two opposite portions. These opening ends 60C are more particularly plugged, for example, by a plug 70 (shown in FIGS. 4 and 5). The secondary channels 166C for their part fluidly connect the main channel 165 to the portion 103C of the first thermal exchange plate 10C, which allows fluid connection with the second thermal exchange plate 10B.

The second thermal exchange plate 10B for its part comprises a supply duct 161B and a discharge duct 162B, both extending in the same plane as said second thermal exchange plate 10B. The supply duct 161B comprises a heat-transfer fluid inlet on the portion 103B of the second thermal exchange plate 10B adhered to the thermal exchange and connection plate 10A and a heat-transfer fluid outlet at the heat-transfer fluid inlet of the circulation duct 16C of the first thermal exchange plate 10C. The discharge duct 162B for its part comprises a heat-transfer fluid outlet on the portion 103B of the second thermal exchange plate 10B adhered to the thermal exchange and connection plate 10A and a heat-transfer fluid inlet at the heat-transfer fluid outlet of the circulation duct 16C of the first thermal exchange plate 10C. The discharge duct 161B and the discharge duct 162b can be separate from each other or even can be formed from the same circulation channel, called main channel 165B, separated in two by a partition 17B, as illustrated in FIGS. 2 and 3.

In the example of FIGS. 2 and 3, the second thermal exchange plate 10B comprises a circulation channel, called main channel 165B. This main channel 165B can be machined in the thickness of the second thermal exchange plate 10B or the main channel 165B even can be formed at the same time as the second thermal exchange plate 10B if said plate is extruded. The main channel 165B thus comprises at least one end 60B opening at a portion of the second thermal exchange plate 10B. In FIGS. 2 and 3, the main channel 165B comprises two opening ends 60C at two opposite portions. These opening ends 60B are more particularly plugged, for example, by a plug 70 (shown in FIGS. 4 and 5).

The second thermal exchange plate 10B also comprises a partition 17B separating the main channel 165B into two mutually separate and sealed portions. The second thermal exchange plate 10B also comprises two chambers 18B, which are also machined and which allow fluid connection between the secondary channels 166C of the first thermal exchange plate 10C and the main channel 165B of the second thermal exchange plate 10B. These chambers 18B are machined on the opposite face of the second thermal exchange plate 10B opposite that which is adhered to the first exchange plate 10B and are covered by a plug 70 (shown in FIGS. 4 and 5).

The second thermal exchange plate 10B also comprises two secondary channels 166B, which fluidly connect the main channel 165B to the portion 103B of the second thermal exchange plate 10B. This allows fluid connection with the thermal exchange and connection plate 10A. The supply duct 161B is thus made up of a secondary channel 166B connected to a portion of the main channel 165B and to a chamber 18B. The discharge duct 162B is, for its part, made up of another secondary channel 166B connected to the other portion of the main channel 165B and to another chamber 18B.

The thermal exchange and connection plate 10A for its part comprises two connection fittings 20, 20′. A first connection fitting 20 is connected to the heat-transfer fluid inlet of the supply duct 161B and a second connection fitting 20′ is connected to the heat-transfer fluid outlet of the discharge duct 162B.

According to a first embodiment illustrated in FIG. 2, the thermal exchange and connection plate 10A comprises two circulation channels 16A, 16A′. A first circulation channel 16A allows fluid connection between the first connection fitting 20 and the supply duct 161B. A second circulation channel 16A′ allows fluid connection between the second connection fitting 20′ and the discharge duct 162B. These circulation channels 16A, 16A′ also can be directly machined in the thickness of the thermal exchange and connection plate 10A or even can be produced at the same time as the thermal exchange and connection plate 10A if said plate is extruded. The connection fittings 20, 20′ thus can be disposed anywhere on any wall 101A, 101B of the thermal exchange and connection plate 10A.

According to a second embodiment illustrated in FIG. 3, the connection fittings 20, 20′ are disposed directly in line with the heat-transfer fluid inlet of the supply duct 161B and of the heat-transfer fluid outlet of the discharge duct 162B.

In the embodiments of FIGS. 2 and 3, electrical storage devices can be placed on the first thermal exchange plate 10C, as well as on the thermal exchange and connection plate 10A, with one of the sides thereof in contact with the second thermal exchange plate 10B.

The various thermal exchange plates 10A, 10B and 10C can be fixed together by screws (not shown). Seals particularly can be placed at the fluid connections between the various ducts and channels of the thermal exchange plates 10A, 10B and 10C to avoid any leaks.

FIGS. 4 to 7 show further details of the closure of an opening end 60A, 60B, 60C of a circulation channel 16A, 16A′, 165B, 165C by a plug 70. The plug 70 is, more particularly, crimped on the portion of the thermal exchange plate 10A, 10B, 10C.

As illustrated in FIG. 4, the portion of the thermal exchange plate 10A, 10B, 10C comprises a recess 61 at the opening end 60A, 60B, 60C of the circulation channel 16A, 16A′, 165B, 165C. Preferably, this recess 61 is produced over the entire thickness of the portion.

The plug 70 is inserted inside this recess 61. The plug 70 comprises an upper part 71 covering the opening end 60A, 60B, 60C. The height of this upper part 71 is lower than the depth of the recess 61. The recess 61 comprises, for its part, on the rims 610 thereof, at least two portions 62 that are at least locally flattened and pushed toward the inside of said recess 61 so as to at least partially cover the edges of the upper part 71 of the plug 70. FIGS. 4 and 5 show a single rim 610 and a single flattened portion 62. A second rim 610 with a second flattened portion 62 is present on the other side of the recess 61 in order to retain the plug 70.

Crimping the plug 70 on the thermal exchange plate 10A, 10B, 10C provides the seal for the circulation channels 16A, 16A′, 165B, 165C without having to use heavy and energy-intensive means such as brazing.

According to a first embodiment illustrated in FIG. 4, the rims 610 are flattened and pushed toward the inside of the recess 61 over the entire thickness of the portion of the thermal exchange plate 10A, 10B, 10C. This fixing by crimping the plug 70 over the entire thickness of the portion of the thermal exchange plate 10A, 10B, 10C allows pressures of the order of 10 bar to be resisted, which is much greater than the average pressure experienced by this part during use. Furthermore, faults only appear beyond 200,000 cycles for cycled pressures of 0.2 to 7 bar, which is also much higher than the recommendations in the field.

According to a second embodiment illustrated in FIG. 5, the rims 610 are flattened and pushed toward the inside of the recess 61 over part of the thickness of the section of the thermal exchange plate 10A, 10B, 10C. This fixing by crimping the plug 70 over part of the thickness of the portion of the thermal exchange plate 10A, 10B, 10C allows performance levels to be obtained that are similar to those described above.

In order to provide a seal, the plug 70 can comprise a seal 81 disposed between the upper part 71 thereof and the bottom of the recess 61. During crimping, this seal 81 is compressed to provide a good seal.

As illustrated in FIG. 6, the opening end 60A, 60B, 60C of the circulation channel 16A, 16A′, 165B, 165C can form an opening 63. The plug 70 for its part can comprise a tenon 72 disposed perpendicular to the upper part thereof 71, as illustrated in FIG. 7. This tenon 72 is particularly inserted into the opening 63.

The opening 63 and the circulation channel 16A, 16A′, 165B, 165C more particularly can have an oblong section. The opening 63 then can be longer than the circulation channel 16A, 16A′, 165B, 165C, so as to form two shoulders 64 at the bottom of the opening 63. The tenon 72 of the plug 70 is then positioned facing the shoulders 64 when the plug 70 is in place. More specifically, it is the ends of the tenon 72 that are each positioned facing a shoulder 64.

In order to provide the seal, the plug 70 can also comprise a seal 82 surrounding the tenon 72. This seal 82 surrounding the tenon 72 comes into contact with the internal wall of the opening 63 when the plug 70 is in place.

Preferably, the seal 81 disposed between the upper part 71 of the plug 70 and the bottom of the recess 61 is produced in one piece with the seal 82 surrounding the tenon 72. This allows only one seal 81, 82 to be provided that is easy to install on the plug 70.

Thus, it clearly can be seen that attaching a plug 70 by crimping at the circulation channels 16A, 16A′, 165B, 165C allows simple, rapid and inexpensive attachment.

1. A thermal management device for an electrical storage device for a motor vehicle, said thermal management device comprising:
at least one thermal exchange plate, inside which a thermal exchange circuit is provided, inside which a heat-transfer fluid is intended to circulate,
the thermal exchange plate comprising a circulation channel, at least one of the ends of which opens into one of a plurality of portions of said thermal exchange plate, said opening end being obstructed by a plug,
wherein the plug is crimped on the one portion of the thermal exchange plate,
said portion comprising, at the opening end of the circulation channel, a recess, inside which the plug is inserted,
the plug comprising an upper part covering the opening end and having a height that is less than the depth of said recess, the recess comprising, on the rims thereof, at least two portions that are at least locally flattened and pushed toward the inside of said recess, so as to at least partially cover the edges of the upper part of the plug.

2. The thermal management device as claimed in claim 1, wherein the recess is produced over the entire thickness of the portion.

3. The thermal management device as claimed in claim 1, wherein the rims of the recess are flattened and pushed toward the inside of the recess over the entire thickness of the portion.

4. The thermal management device as claimed in claim 1, wherein the rims of the recess are flattened and pushed toward the inside of the recess over part of the thickness of the portion.

5. The thermal management device as claimed in claim 1, wherein the plug comprises a seal disposed between the upper part thereof and the bottom of the recess.

6. The thermal management device as claimed in claim 5, wherein the opening end of the circulation channel forms an opening and wherein the plug comprises a tenon disposed perpendicular to the upper part thereof, said tenon being inserted inside said opening.

7. The thermal management device as claimed in claim 6, wherein the opening and the circulation channel have an oblong section, said opening being longer than said circulation channel, so as to form two shoulders at the bottom of said opening, the tenon of the plug facing said shoulders.

8. The thermal management device as claimed in claim 6, wherein the plug comprises a seal surrounding the tenon and coming into contact with the internal wall of the opening.

9. The thermal management device as claimed in claim 8, wherein in that the seal disposed between the upper part of the plug and the bottom of the recess is produced in one piece with the seal surrounding the tenon.

10. A thermal management device for an electrical storage device for a motor vehicle, said thermal management device comprising:
a first thermal exchange plate extending in a first plane, a second thermal exchange plate extending in a second plane intersecting the first plane and adhered to one of a plurality of portions of the first thermal exchange plate, and a third thermal exchange plate being in a third plane parallel to the first plane and adhered to a portion of the second thermal exchange plate,
wherein inside the first thermal exchange plate a thermal exchange circuit is provided, the thermal exchange circuit having a circulation duct in which a heat-transfer fluid circulates,
the circulation duct comprising a circulation channel, at least one of the ends of which opens into one of the plurality of portions of said first thermal exchange plate, said opening end being obstructed by a plug,
wherein the plug is crimped on the one portion of the first thermal exchange plate,
said portion comprising, at the opening end of the circulation channel, a recess, inside which the plug is inserted,
the plug comprising an upper part covering the opening end and having a height that is less than the depth of said recess, the recess comprising, on the rims thereof, at least two portions that are at least locally flattened and pushed toward the inside of said recess, so as to at least partially cover the edges of the upper part of the plug.
